(19) United States
(12) Patent Application Publication
(10) Pub. No.: US 2009/0219233 A1
(43) Pub. Date: Sep. 3, 2009

(54) ORGANIC LIGHT EMITTING DISPLAY AND METHOD OF DRIVING THE SAME

(76) Inventor: Yong-Sung Park, Suwon-si (KR)

Correspondence Address: CHRISTIE, PARKER & HALE, LLP, PO BOX 7068, PASADENA, CA, 91109-7068, US

(21) Appl. No.: 12/371,343

(22) Filed: Feb. 13, 2009

(30) Foreign Application Priority Data
Mar. 3, 2008 (KR) 10-2008-0019582

(51) Int. Cl. G09G 3/30

(52) U.S. Cl. 345/80

(57) ABSTRACT

An organic light emitting display and a method of driving the same. The organic light emitting display includes: a display unit having a plurality of data lines, a plurality of scan lines, and a plurality of pixels at crossing regions of the plurality of data lines and the plurality of scan lines; a data driver for outputting data signals through output channels, an output channel of the output channels coupled to two data lines of the plurality of data lines; a first scan driver for transferring scan signals to pixels coupled to one data line of the two data lines; and a second scan driver for transferring scan signals to pixels coupled to the other data line of the two data lines.

### CROSS-REFERENCE TO RELATED APPLICATIONS

This application claims priority to and the benefit of Korean Patent Application No. 10-2008-0019582, filed on Mar. 3, 2008, in the Korean Intellectual Property Office, the entire content of which is incorporated herein by reference.

### BACKGROUND OF THE INVENTION

1. Field of the Invention

The present invention relates to an organic light emitting display and a method of driving the same.

2. Description of Related Art

Recently, various flat panel displays with reduced weight and volume in comparison to a cathode ray tube display have been developed. The various flat panel displays include a liquid crystal display, a field emission display, a plasma display panel, an organic light emitting display, etc.

Among others, the organic light emitting display displays an image using organic light emitting diodes (OLEDs) that generate light by recombination of electrons and holes.

The organic light emitting display has various advantages such as excellent color reproducibility and a slim profile so that it is widely used in a variety of applications such as application in a PDA, an MP3 player, etc., in addition to a cellular phone application.

In general, the organic light emitting display includes a display unit that includes a plurality of pixels, and a scan driver and a data driver for supplying scan signals and data signals to the display unit, respectively.

Also, the organic light emitting display further includes a demultiplexer that distributes the data signals output through one output channel of the data driver to a plurality of data lines. When such a demultiplexer is adopted, the number of output channels of the data driver can be reduced.

However, when multiple data lines receive data signals through one output channel of the data driver, a transferring time is divided among the multiple data signals so that portions of the transferring time available for each of the data signals become short. When the portions of the transferring time of the data signals become short, the charging time of the data signals in the data lines is insufficient.

In particular, in the case of digital driving, one frame is divided into multiple subframes, and data signals are transferred per each subframe. Therefore, in comparison to analog driving, the transferring times of the data signals in digital driving is even shorter so that the charging times of the data signals become more insufficient. Also, when using the demultiplexer, the data signals are affected by thin film transistors included in the demultiplexer so that the charging times of the data signals in the data lines become more insufficient.

### SUMMARY OF THE INVENTION

Embodiments of the present invention provide an organic light emitting display and a method of driving the same, wherein the number of output channels of a data driver is fewer than the number of data lines, and the charging time of a data signal in each data line is reduced, thereby improving data signal characteristics.

According to an embodiment of the present invention, there is provided an organic light emitting display including: a display unit having a plurality of data lines, a plurality of scan lines, and a plurality of pixels at crossing regions of the plurality of data lines and the plurality of scan lines; a data driver for outputting data signals through output channels, an output channel of the output channels coupled to two data lines of the plurality of data lines; a first scan driver for transferring scan signals to a pixel of the plurality of pixels coupled to one data line of the two data lines; and a second scan driver for transferring scan signals to another pixel of the plurality of pixels coupled to the other data line of the two data lines.

According to another embodiment of the present invention, there is provided a method of driving an organic light emitting display. The method includes: concurrently outputting a first data signal to two data lines; transferring the first data signal to one data line of the two data lines corresponding to a first scan signal; concurrently outputting a second data signal to the two data lines; and transferring the second data signal to another data line of the two data lines corresponding to a second scan signal.

According to still another embodiment of the present invention, there is provided an organic light emitting display including: a display unit having a plurality of data lines, a plurality of scan lines, and a plurality of pixels at crossing regions of the plurality of data lines and the plurality of scan lines; a data driver for outputting data signals through output channels, an output channel of the output channels coupled to at least two data lines of the plurality of data lines; at least two scan drivers each coupled to a corresponding one of the at least two data lines. Each of the at least two scan drivers is configured to transfer scan signals to corresponding pixels of the plurality of pixels coupled to a corresponding one of the at least two data lines.

### BRIEF DESCRIPTION OF THE DRAWINGS

The accompanying drawings, together with the specification illustrate exemplary embodiments of the present invention, and, together with the description, serve to explain the principles of the present invention.

FIG. 1 is a diagram showing one frame of an image according to an embodiment of the present invention;

FIG. 2 is a block diagram showing an organic light emitting display according to a first embodiment of the present invention;

FIG. 3 is a block diagram showing a data driver included in an organic light emitting display according to an embodiment of the present invention; and

FIG. 4 is a block diagram showing an organic light emitting display according to a second embodiment of the present invention.

### DETAILED DESCRIPTION OF EXEMPLARY EMBODIMENTS

Hereinafter, certain exemplary embodiments according to the present invention will be described with reference to the accompany drawings. Herein, when a first element is described as being coupled to a second element, the first element may be directly coupled to the second element or may be indirectly coupled to the second element via a third element. Further, some of the elements that are not essential to the complete understanding of the invention are omitted for clarity. Also, like reference numerals refer to like element throughout.

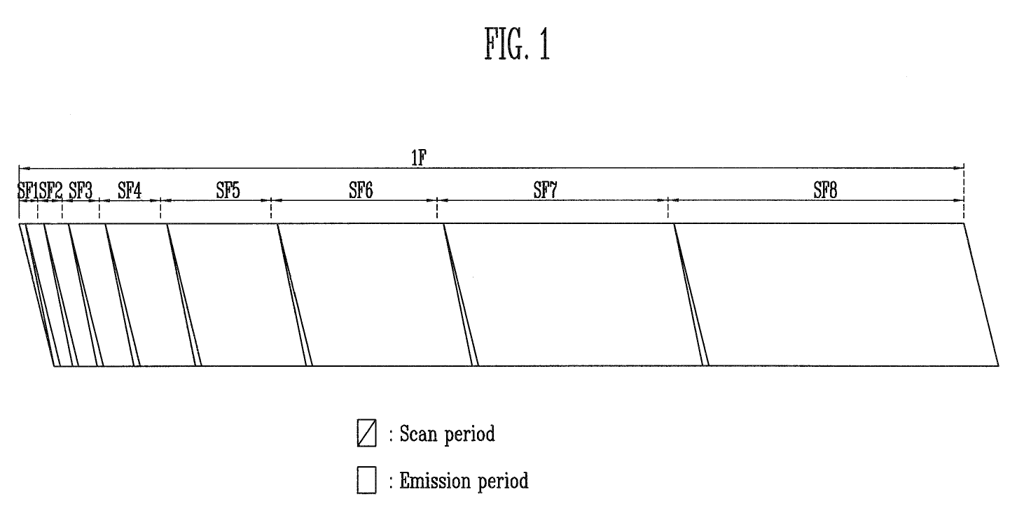

FIG. 1 is a diagram showing one frame of an image according to an embodiment of the present invention. Referring to FIG. 1, one frame 1 F is driven by being divided into a plurality of subframes SF1 to SF8. Each of the subframes SF1 to SF8 is divided into a scan period for supplying scan signals and a light emitting period where pixels supplied with data signals during the scan period emit light.

During the scan period, the scan signals are supplied to scan lines. At this time, the data signals supplied to data lines are supplied to the pixels. The pixels supplied with the scan signals are supplied with the data signals.

During the light emitting period, the pixels emit light or do not emit light according to the data signals, while maintaining the data signals supplied during the scan period.

In order to represent gray levels (e.g., a predetermined gray levels), the light emitting periods are differently set in the respective subframes SF1 to SF8. For example, when displaying an image with 256 gray levels, one frame is divided into eight subframes SF1 to SF8, as shown in FIG. 1. The light emitting periods in the respective eight subframes SF1 to SF8 increase in the order of 2ⁿ(n=0, 1, 2, 3, 4, 5, 6, 7). In other words, according to an embodiment of the present invention, an image is displayed at gray levels (e.g., a predetermined grays level) while the pixels are being controlled to emit or not to emit light during the respective subframes. In other words, gray levels (e.g., predetermined gray levels) is represented during one frame period by a sum of light-emitting time of the pixels during the subframe periods. Digital driving represents gray levels using a turn-on state or a turn-off state of the pixels so that it can display an image having even brightness, regardless of variations among driving transistors included in the respective pixels.

The one frame of FIG. 1 illustrates an exemplary embodiment of the present invention, but the present invention is not limited thereto. For example, one frame may be divided into fifteen or more subframes, and the light emitting periods of the respective subframes may be variously set. Each of the subframes may further include a reset period, in addition to the scan period and the light emitting period. The reset period is used for setting the pixels to an initialization state.

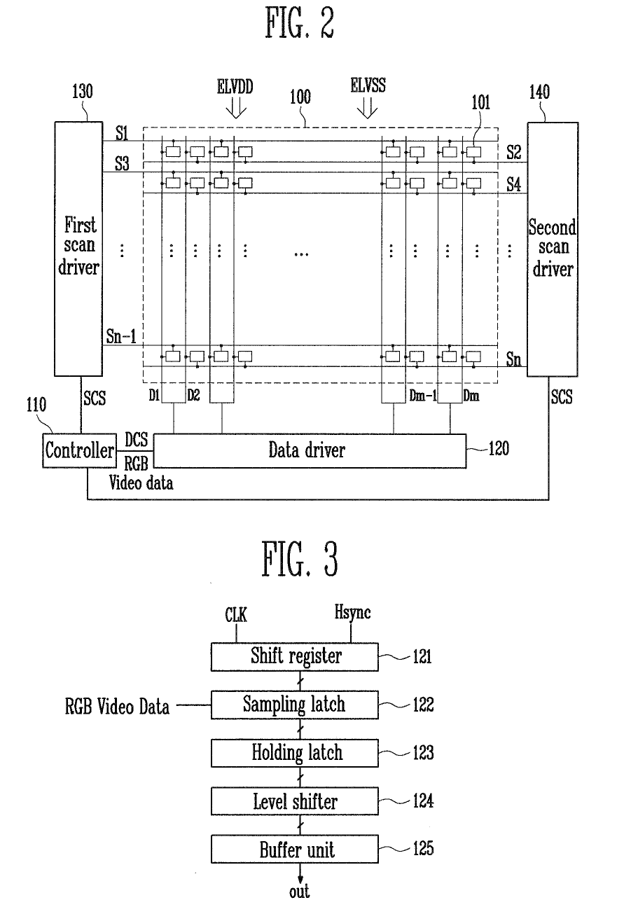

FIG. 2 is a block diagram showing an organic light emitting display according to a first embodiment of the present invention. Referring to FIG. 2, the organic light emitting display includes a display unit 100, a controller 110, a data driver 120, a first scan driver 130, and a second scan driver 140.

The display unit 100 includes a plurality of pixels 101, each of which includes an organic light emitting diode (not shown) that emits light corresponding to a flow of current through the organic light emitting diode. Also, the display unit 100 includes a plurality of scan lines S1, S2, . . . Sn-1, and Sn extending in a row direction for transferring scan signals; and a plurality of data lines D1, D2, . . . , Dm-1, and Dm extending in a column direction for transferring data signals. Also, the display unit 100 receives a first power ELVDD and a second power ELVSS supplied from the outside.

The controller 110 generates an RGB video signal (i.e., RGB video data), a data driver control signal DCS, a scan driver control signal SCS, etc. and transfers them to a data driver 120, first and second scan drivers 130 and 140, etc.

The data driver 120 generates data signals and outputs the data signals through output channels. The data driver 120 receives the RGB video signal (i.e., RGB video data) having red, blue, and green components to generate the data signals. Each of the output channels of the data driver 120 is coupled to two data lines that are coupled to two adjacent pixel columns among the data lines D1, D2 . . . Dm-1, and Dm of the display unit 100.

The first scan driver 130 is coupled to odd scan lines among the scan lines S1, S2 . . . Sn-1, and Sn to transfer the scan signals to the odd scan lines of the display unit 100. The second scan driver 140 is coupled to even scan lines among the scan lines S1, S2 . . . Sn-1, and Sn to transfer the scan signals to the even scan lines of the display unit 100.

When the data signals are output through the output channels of the data driver 120, the first scan driver 130 applies the scan signals to the odd scan lines (e.g., S1, S3, . . . , etc.) first, and the data signals are transferred to the pixels coupled to the odd data lines (e.g., D1, D3, . . . , etc.). When the data signals are output again by the output channels of the data driver 120, the second scan driver 140 applies the scan signals to the even scan lines, and the data signals are transferred to the pixels coupled to the even data lines (e.g., D2, D4 . . . etc.).

In other words, two data signals output through one output channel are selectively transferred to odd pixel columns coupled to the odd data lines or even pixel columns coupled to the even data lines according to the scan signals output from the first scan driver 130 or the second scan driver 140. Therefore, despite not using a demultiplexer, the two data signals output through one output channel are transferred to one of the two data lines, making it possible to reduce the number of output channels of the data driver 120.

Here, a first scan signal output from the first scan driver 130 and a first scan signal output from the second scan driver 140 are supplied during a first subframe. A second scan signal output from the first scan driver 130 and a second scan signal output from the second scan driver 140 are supplied during a second subframe. In other words, two scan signals are supplied during one subframe so that data signals can be transferred to the pixels during one subframe.

FIG. 3 is a block diagram showing a data driver of an organic light emitting display according to an embodiment of the present invention. Referring to FIG. 3, a data driver 120 includes a shift register 121, a sampling latch 122, a holding latch 123, a level shifter 124, and a buffer unit 125.

The shift register 121, configured of a plurality of flip-flops, controls the sampling latch 122 according to a clock signal CLK and a synchronization signal Hsync. The sampling latch 122 is sequentially input with the data signals of the RGB video data of one row of an image according to control signals of the shift register 121 to output them in parallel. This scheme of sequentially inputting signals and outputting them in parallel is referred to as serial in parallel out (SIPO). The holding latch 123 receives the data signals in parallel and outputs them in parallel again. This scheme of inputting signals in parallel and outputting them in parallel is referred to as parallel in parallel out (PIPO). The level shifter 124 changes a voltage level of the data signals output from the holding latch 123 into a voltage level within the operation voltage range of the system, and transfers the data signals output from the level shifter 124 to the buffer unit 125, which then outputs the data signals. The buffer unit 125 includes a plurality of output channels (not shown) and outputs the data signals in parallel through the output channels.

The data signals output from the buffer unit 125 are directly transferred to the data lines (e.g., D1, D2 . . . Dm-1, and Dm) without passing through a demultiplexer, etc. Therefore, the data signals are not affected by thin film transistors included in the demultiplexer so that signal characteristics of the data signals are improved to reduce charging time of the data signals in the data lines.

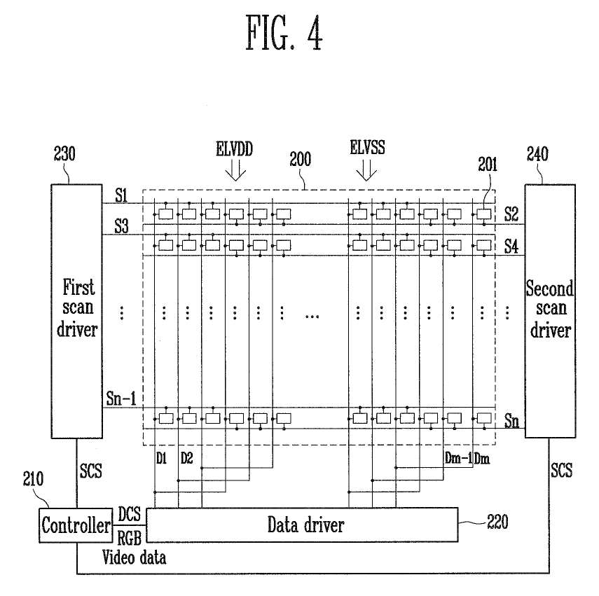

FIG. 4 is a block diagram showing an organic light emitting display according to a second embodiment of the present invention. Referring to FIG. 4, the organic light emitting display includes a display unit 200, a controller 210, a data driver 220, a first scan driver 230, and a second scan driver 240.

The display unit 200 includes a plurality of pixels 201, each of which includes an organic light emitting diode (not shown) for emitting light corresponding to a flow of current through the organic light emitting diode. Also, the display unit 200 includes a plurality of scan lines S1, S2 . . . Sn-1, and Sn extending in a row direction for transferring scan signals; and a plurality of data lines D1, D2 . . . Dm-1, and Dm extending in a column direction for transferring data signals. Also, the display unit 200 receives a first power ELVDD and a second power ELVSS supplied from the outside.

The controller 210 generates a RGB video signal RGB video data, a data driver control signal DCS, a scan driver control signal SCS, etc. to transfer them to the data driver 220, the first scan driver 230, the second scan driver 240, etc.

The data driver 220 generates data signals and output the data signals through output channels. The data driver 220 receives the RGB video signal (i.e., RGB video data) having red, blue, and green components to generate the data signals. One output channel of the data driver 220 is coupled with an i^{th} (i is a natural number) data line and an i+3^{rd} data line among the plurality of data lines D1, D2, . . . , Dm-1, and Dm to transfer the data signals to the i^{th} data line D1 and the i+3^{rd} data line Di+3.

The first scan driver 230 is coupled with a j^{th} (j is a natural number) scan line Sj and a j+2^{nd} scan line Sj+2 among the plurality of scan lines S1, S2, . . . , Sn-1 and Sn to transfer the scan signals to the j^{th} scan line Sj and the j+2^{nd} scan line Sj+2. The second scan driver 240 is coupled with a j+1^{st} (j is a natural number) scan line Sj+1 and a j+3^{rd} scan line Sj+3 among the plurality of scan lines S1, S2, . . . , Sn-1 and Sn to transfer the scan signals to the j+1^{st} scan line Sj+1 and the j+3^{rd} scan line Sj+3.

A pixel coupled to the j^{th} scan line receives the data signals through the i^{th}, i+1^{st}, and i+2^{nd} data lines, and a pixel coupled to the j+1^{st} scan line receives the data signals through the i+3^{rd}, i+4^{th}, and i+5^{th} data lines.

Therefore, when the data signals are output through the output channels of the data driver 220, the data signals are transferred to the plurality of data lines D1, D2, . . . , Dm-1, and Dm. Here, the pixels coupled to the i^{th}, j+1^{st}, and i+2^{nd} data lines (e.g., D1, D2 and D3) receive the data signals according to the scan signals transferred through the j^{th} scan line (e.g., S1). Then, the pixels coupled to the i+3^{rd}, i+4^{th}, and i+5^{th} data lines (e.g., D4, D5 and D6) receive the data signals according to the scan signals transferred through the j+1^{st} scan line (e.g., S2). Therefore, the data signals transferred through one output channel of the data driver 220 are transferred through two data lines according to the scan signals at different times. In other words, when the first scan driver 230 applies the scan signals, a first set of the data signals is transferred through the data lines, and when the second scan driver 240 applies the scan signals, another set of the data signals is transferred through the data lines. Thereby, the data signals transferred through one output channel of the data driver 220 can be transferred to pixels coupled to different data lines. In other words, since no demultiplexer is used, the data signals are not affected by the thin film transistors included in the demultiplexer so that signal characteristics of the data signals are improved to reduce charging time of the data signals in the data lines.

Also, despite not using the demultiplexer, two data signals output through one output channel are transferred to one of two data lines, making it possible to reduce the number of output channels of the data driver.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display comprising:
a display unit having a plurality of data lines, a plurality of scan lines, and a plurality of pixels at crossing regions of the plurality of data lines and the plurality of scan lines;
a data driver for outputting data signals through output channels, an output channel of the output channels coupled to two data lines of the plurality of data lines;
a first scan driver for transferring scan signals to a pixel of the plurality of pixels coupled to one data line of the two data lines; and
a second scan driver for transferring scan signals to another pixel of the plurality of pixels coupled to the other data line of the two data lines.

2. The organic light emitting display as claimed in claim 1, wherein the two data lines transfer the data signals to two adjacent pixel columns among the plurality of pixels, respectively.

3. The organic light emitting display as claimed in claim 2, wherein the first scan driver is configured to transfer the scan signals to pixels among the plurality of pixels coupled to odd data lines among the data lines, and the second scan driver is configured to transfer the scan signals to pixels among the plurality of pixels coupled to even data lines among the data lines.

4. The organic light emitting display as claimed in claim 1, wherein the two data lines transfer the data signals to an i^{th} pixel column among the plurality of pixels and an i+3^{rd} pixel column among the plurality of pixels, respectively.

5. The organic light emitting display as claimed in claim 4, wherein the first scan driver is configured to transfer the scan signals to pixels among the plurality of pixels coupled to a j^{th} scan line and a j+2^{nd} scan line, and the second scan driver is configured to transfer the scan signals to pixels among the plurality of pixels coupled to a j+1^{st} scan line and a j+3^{rd} scan line.

6. The organic light emitting display as claimed in claim 1, wherein one frame displayed by the display unit comprises a plurality of subframes, and corresponding data signals among the data signals are transferred during each of the plurality of subframes.

7. A method of driving an organic light emitting display, the method comprising:
concurrently outputting a first data signal to two data lines;
transferring the first data signal to one data line of the two data lines corresponding to a first scan signal;
concurrently outputting a second data signal to the two data lines; and
transferring the second data signal to another data line of the two data lines corresponding to a second scan signal.

8. The method of driving the organic light emitting display as claimed in claim 7, wherein the first scan signal is supplied by a first scan driver, and the second scan signal is supplied by a second scan driver.

9. The method of driving the organic light emitting display as claimed in claim 7, wherein the first data signal and the second data signal are output from a same output channel of a data driver.

10. The method of driving the organic light emitting display as claimed in claim 7, wherein the first data signal and the second data signal are transferred during one subframe.

11. The driving method of the organic light emitting display as claimed in claim 7, wherein the first scan signal and the second scan signal are transferred during one subframe.
